(19) United States
(12) Patent Application Publication
(10) Pub. No.: US 2010/0016052 A1
(43) Pub. Date: Jan. 21, 2010

(54) LOCATION-LINKED AUDIO/VIDEO

(75) Inventors: Mark B. Gagner, West Chicago, IL (US); Laurie Lasseter, Wood Ridge, IL (US); Steven J. Lee, Naperville, IL (US); Craig J. Sylla, Round Lake, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc., Waukegan, IL (US)

(21) Appl. No.: 12/444,199

(22) PCT Filed: Oct. 10, 2007
(86) PCT No.: PCT/US07/21608

§ 371 Date: Apr. 3, 2009

Related U.S. Application Data
(60) Provisional application No. 60/828,992, filed on Oct. 11, 2006.

(51) Int. Cl. A63F 9/24; A63F 13/00

(52) U.S. Cl. 463/16; 463/29; 463/42; 463/31

(57) ABSTRACT

Apparatus, systems, and methods may operate to determine the location of a selected person in a casino, detect the occurrence of a preselected event associated with the selected person, and display a video image of the selected person on a display responsive to the detecting. Other apparatus, systems, and methods are disclosed.

### RELATED APPLICATIONS

This patent application claims the priority benefit of U.S. Provisional Patent Application Ser. No. 60/828,992 filed Oct. 11, 2006 and entitled “LOCATION-LINKED AUDIO/VIDEO”, which application is incorporated herein by reference.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent records, but otherwise reserves all copyright rights whatsoever. Copyright 2006, 2007, WMS Gaming, Inc.

### FIELD

Embodiments of the inventive subject matter relate generally to environments surrounding wagering game systems, such as casinos and other venues, including monitoring the location of wagering game machine patrons and others in a casino environment.

### BACKGROUND

Casinos and other locations where wagering game machines are deployed typically comprise large buildings. Labyrinthine layouts are often used to provide amusement and maintain customer interest. Lighting and sound often vary throughout the gaming area, providing additional variety. While such features lend themselves to a more enjoyable gaming experience, they can also be confusing to those that choose to move about the building, going from one place to another. In addition, it can be difficult for patrons to keep track of friends and family that may be present in the building. Thus, there is a need for improved mechanisms for locating patrons and others in buildings and other locales where wagering game machines are used.

### BRIEF DESCRIPTION OF THE DRAWINGS

Embodiments of the invention are illustrated by way of example and not limitation in the figures of the accompanying drawings in which:

FIG. 1A is a block diagram of a wagering apparatus and a wagering game machine, according to example embodiments of the invention.

FIG. 1B is a block diagram of a tag, according to example embodiments of the invention.

FIG. 2 is a block diagram illustrating a wagering game network, according to example embodiments of the invention.

FIG. 3 is a flowchart illustrating various methods of linking locations to selected rules, events, and persons, according to example embodiments of the invention.

FIG. 4 is a perspective view of a free standing wagering game machine, according to example embodiments of the invention.

FIG. 5 is a perspective view of a mobile wagering game machine, according to example embodiments of the invention.

### DETAILED DESCRIPTION

### Example Operating Environment

### Example Wagering Game Machine Architecture

In order to provide a convenient link between the location of casino patrons and others in environments surrounding wagering game machines, an image of a person at a predetermined location can be delivered to a monitor located in a wagering game machine, or at some other location, such as a bar in a casino, a security monitoring facility, a hotel room, or even across a global computer network, such as the Internet, to a personal computer. Rules and events may be selectively monitored so that when the conditions of a rule are met, or a monitored event occurs, the image is displayed.

Many variations are possible, such as recording images from one or more locations, and playing back images of selected persons. A tag may be attached to or carried by one or more selected persons to assist in tracking them as they move about, and one-way/two-way communication with the selected person(s) may be accomplished via audio, video, and other means. Entertainment events may be triggered by the location of the selected person(s). In some embodiments, location information may be used to implement automatic casino gaming floor management.

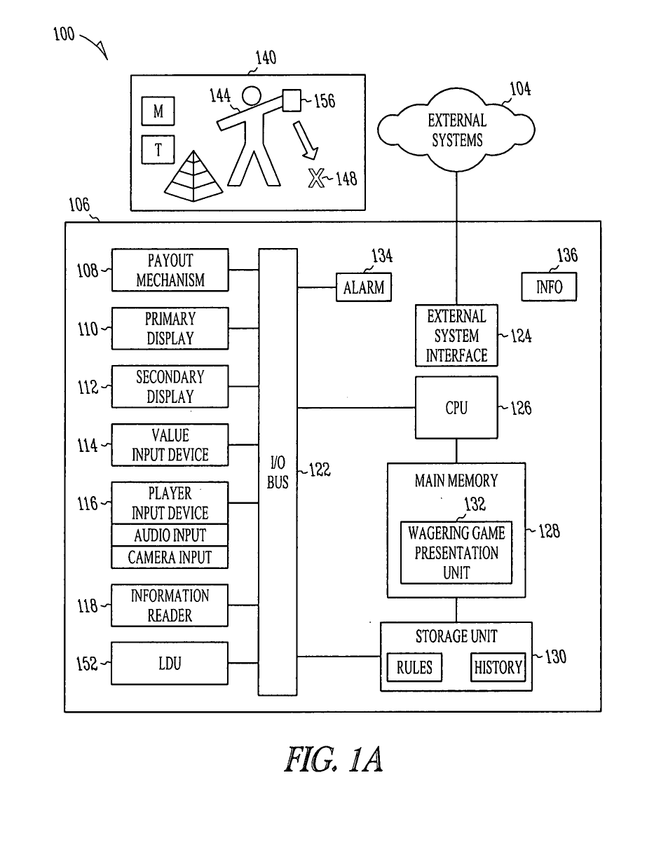

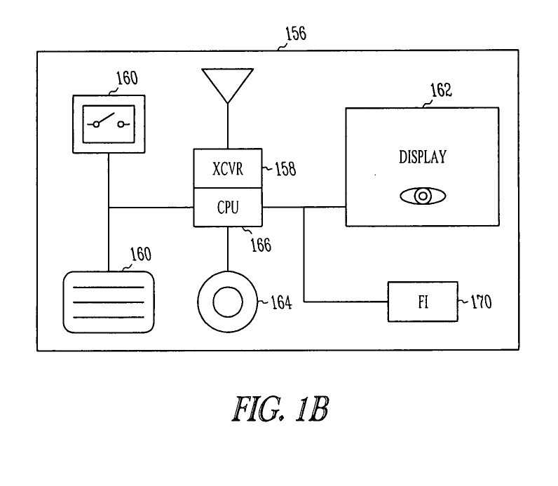

FIG. 1A is a block diagram of a wagering apparatus 100 and a wagering game machine 106, according to example embodiments of the invention. The wagering game machine 106 may include a central processing unit (CPU) 126 connected to main memory 128, which includes a wagering game presentation unit 132. In some embodiments, the wagering game presentation unit 132 can present wagering games, such as video poker, video blackjack, video slots, video lottery, etc., in whole or in part. The wagering game presentation unit 132 is operable to receive a wager from a player in association with a wagering game to be presented to the player.

The CPU 126 may be connected to an input/output (I/O) bus 122, which facilitates communication between the wagering game machine's components. The I/O bus 122 may, in turn, be connected to a payout mechanism 108, a primary display 110, a secondary display 112, a value input device 114 (to indicate the placement of wagers), a player input device 116, an information reader 118, and a storage unit 130. The player input device 116 can include the value input device 114 to the extent the player input device 116 is used to place wagers. The I/O bus 122 may also be connected to an external system interface 124, which can be coupled to external systems 104 (e.g., wagering game networks), perhaps via wired and/or wireless networks.

In some embodiments, the wagering game machine 106 can include additional peripheral devices and/or more than one of each component shown in FIG. 1. For example, in some embodiments, the wagering game machine 106 includes multiple external system interfaces 124 and multiple CPUs 126. In some embodiments, any of the components can be integrated or subdivided. Additionally, in some embodiments, the components of the wagering game machine 106 can be interconnected according to any suitable interconnection architecture (e.g., directly connected, hypercube, in series, etc.).

In some embodiments, any of the components of the wagering game machine 106 (e.g., the wagering game presentation unit 132) can include hardware, firmware, and/or software for performing the operations described herein. Machine-readable media includes any mechanism that provides (i.e., stores and/or transmits) information in a form readable by a machine (e.g., a wagering game machine, computer, etc.). For example, tangible machine-readable media may include read only memory (ROM), random access memory (RAM), magnetic disk storage media, optical storage media, flash memory devices, etc. Machine-readable media may include any medium suitable for transmitting software over a network.

As shown in FIG. 1A, many embodiments may be realized. For example, in some embodiments, an apparatus 100 may include a wagering game machine 106 having a wagering game presentation unit 132 operable to receive a wager from a player in association with a wagering game. The apparatus 100 may include one or more displays 110, 112 to present an image 140 of a person 144 at a predetermined location 148, wherein the person 144 is selected by the player.

For the purposes of this document, a “predetermined location” 148 is the location of a selected person 144 that has been previously determined with respect to another person, an object or group of objects, or a coordinate system—electronic, absolute, or otherwise. The displays 110, 112 may be located within the wagering game machine 106, or apart from it. That is, the displays 110, 112 may be communicatively coupled to the wagering game machine 106, and located remotely. In some embodiments, one display (e.g., secondary display 112) is included as a part of a picture-in-picture display of another display (e.g., primary display 110) in the wagering game machine 106.

The apparatus 100, or the wagering game machine 106, may include a location determination unit 152 to determine the predetermined location 148, which may be determined in a variety of ways. For example, by using location information 136, such as coordinates derived from audio, radio, or light time-of-arrival information, angle-of-arrival information, time-difference of arrival information, phase-difference of arrival information, and global positioning system (GPS) information, as is known to those of ordinary skill in the art, the predetermined location 148 of a selected person may be resolved. For example, the Real Time Location System available from Ubisense Limited of Cambridge, England that operates with control and sensing frequencies that range from about 1 Ghz to about 8 Ghz, may be used to resolve the predetermined location 148 of a person 144. Similarly, the multilateration system documented in U.S. Patent Application Ser. No. 60/746,785, commonly assigned to the assignee of this disclosure, and incorporated herein by reference in its entirety, may also be used for this purpose. In the Ubisense system, as well as in several others, one or more tags 156 can be attached to the selected person 144 to assist in providing data for resolving the predetermined location 148.

As will be discussed in more detail below, the image 140 of the selected person 144 may be enhanced by including other information, some of a practical nature, and some for the purposes of entertainment. For example, the image 140 may include a time-stamp T associated with the time the predetermined location 148 is determined, or resolved. The image 140 may comprise a composite scene (e.g., including palm trees, pyramids located in exotic locales, and other objects) that also includes the person 144. Other variations are possible. The display 110, 112 may be used to display the map M of a route from the predetermined location 148 to the wagering game machine 106. The map M may form a part of the image 140, or be located apart from the image, on the same display, or on another display.

Depending on the preferences of the viewer, the selected person 144, or others, the image 140 may be displayed so as to be blurred around the selected person 144. The image 140 may also be limited to a fixed amount of physical space surrounding the person 144.

The image 140 of the selected person 144 may be transmitted for viewing practically anywhere. Thus, the display 110, 112 may be included in a bar-top display to be viewed by casino personnel, or perhaps in a security video display to be viewed by casino security personnel. In some cases, the image 140 may be communicated (e.g., broadcast) to a global communications network, such as the Internet.

Various rules and events may be monitored to enable or trigger the display of an image 140 of the selected person 144. Thus, display of the image 140 may be activated in response to the predetermined location 148 coinciding with a selected rule. For example, the selected rule may include activating the display 110, 112 responsive to the person 144 leaving a designated area, or entering a designated area. The display of the image 140 may also be activated by detecting the occurrence of a preselected event associated with the selected person 144, such as winning a jackpot, or the reception of a very large wager at a particular wagering game machine 106.

Security concerns may be addressed by some embodiments. For example, an alarm 134 may be activated in response to the predetermined location coinciding with a selected rule (e.g., activate alarm 134 if the selected person 144 lingers too long within a selected distance from where cash money is stored). Or the predetermined location 148 may be correlated with winnings associated with the wagering game machine 106 to detect fraud. The history HISTORY of the predetermined location 148 as it changes over time may be saved in a memory (e.g., storage unit 130) of the wagering game machine 106. This history may be used in a number of ways, to be described below.

FIG. 1B is a block diagram of a tag 156, according to example embodiments of the invention. Turning now to FIGS. 1A and 1B, it can be seen that, as noted previously, tags 156 can be attached to the selected person 144 to assist in providing data for resolving the predetermined location 148. The tag 156 may take a variety of forms, including one or more of a radio-frequency identification (RFID) device, a bracelet, a hotel room card, and a credit card.

In addition, the tag 156 may be equipped with one-way or two-way radio, audio, and/or video communication capability, and many variations are possible. For example, in some embodiments, the tag may include a processor 166 and a transceiver 158. The transceiver 158 may have a communication receiver to receive audio and/or video information directed to the selected person 144. In some embodiments, the tag 156 may further include an audio communication module 160 (e.g., speaker and/or microphone) and/or video communication module 162 (e.g., video display and/or camera) to communicate with the selected person. The tag 156 may also include a vibratory element 164 to convey vibration information to the selected person.

A one-way or two-way function indicator 170 (e.g., a button switch and/or a light-emitting diode or piezo speaker element) included in the tag 156 may be activated by the selected person 144 to indicate that the selected person 144 is requesting assistance from those observing the image (e.g., a waiter at a bar or a security guard at a security viewing station). The function indicator 170 may also be activated remotely, perhaps by an observer of the image 140, to serve as a silent or audible acknowledgment (e.g. a blinking light or audible “beep”) that a previous request has been acknowledged and/or that assistance is on the way to the selected person 144. Two-way communication with the selected person 144 may also be enabled using audio input and/or camera input devices attached to a wagering game machine 106 that displays the image 140 of the selected person, perhaps coupled to a player input device 116.

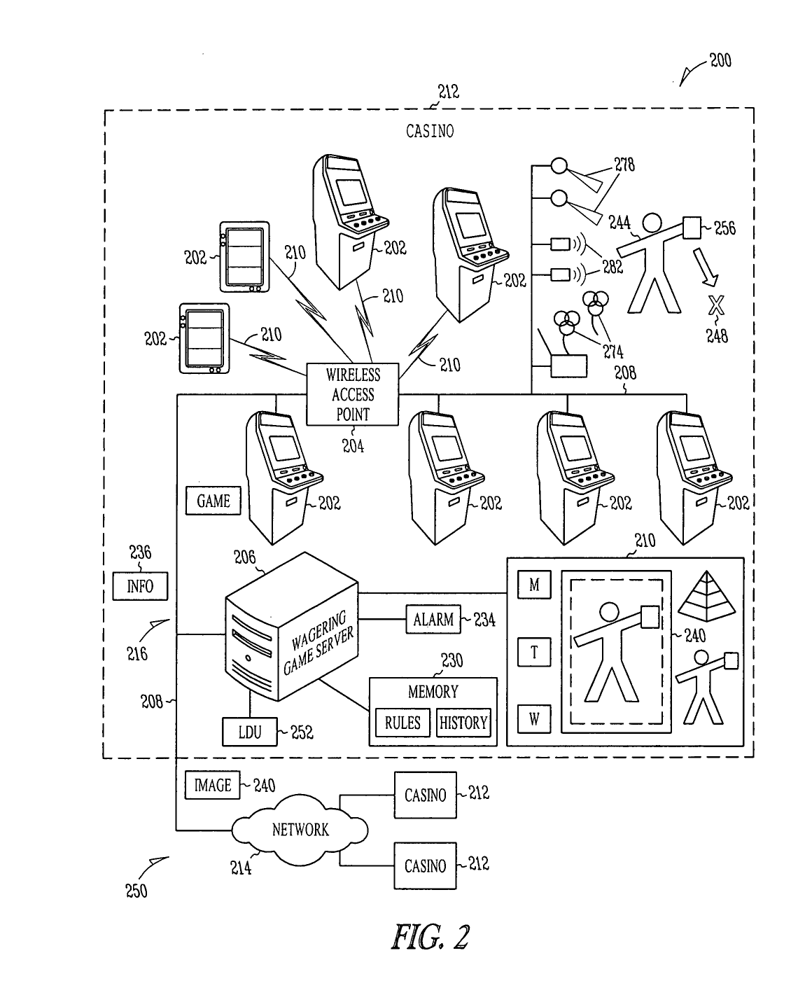

While FIG. 1A describes example embodiments of a wagering game machine architecture, FIG. 2 shows how a plurality of wagering game machines can be connected in a wagering game network.

### Example Wagering Game Network

FIG. 2 is a block diagram illustrating a wagering game network 200, according to example embodiments of the invention. As shown in FIG. 2, the wagering game network 200 may include a plurality of casinos 212 connected to a communications network 214.

Each of the plurality of casinos 212 may include a local area network 216, which includes a wireless access point 204, wagering game machines 202, and a wagering game server 206 that can serve wagering games GAME over the local area network 216. As such, the local area network 216 may include wireless communication links 210 and wired communication links 208. The wired and wireless communication links 208, 210 can employ any suitable connection technology, such as Bluetooth, 802.11, Ethernet, public switched telephone networks, SONET, etc. In some embodiments, the wagering game server 206 can serve wagering games GAME and/or distribute content 236 to devices located in other casinos 212 or at other locations on the communications network 214. The content 236 may include predetermined location information. The wagering game server 206 may be coupled to, or include memory 230, an alarm 234, and an LDU 252, wherein each of these elements are similar to or identical to like elements shown in FIG. 1A (i.e., storage unit 130, alarm 134, and LDU 152).

Thus, many additional embodiments may be realized. For example, a system 250 may include one or more wagering game machine servers 206 coupled to one or more wagering game machines 202 operable to receive wagers in association with wagering games. The system 250 may include one or more displays 210 in communication with the wagering game machine server 206. The display 210 may be used to present an image 240 of a selected person 244 at a predetermined location 248. The display 210 may be similar to or identical to the displays 110, 112 of FIG. 1A. The display 210 may be located in one or more wagering game machines 202, at or near the wagering game server 206, or in any other desired location, such as on a bar in a casino, in a casino hotel room, forming a part of a casino personnel management monitoring station, in a casino equipment repair management monitoring station, or forming a part of a security video display in a casino security monitoring station. In some embodiments, the display 210 may be included in an audio-visual unit (e.g., capable of showing images and projecting audio) disposed apart from the server 206 so that the image 240 is available for viewing by a plurality of casino patrons.

The predetermined location 248 may be determined in a number of ways (see above), and by a number of devices. For example, the predetermined location 248 may be determined by one or more of the wagering game machines 202 (using an LDU 252 located within the machines 202, in the server 206, or elsewhere). Thus, in some embodiments, the wagering game machine server 206 may serve to determine the predetermined location 248. Multiple devices (e.g., the machines 202 and the servers 206) may be used to determine the locations 248 of one or multiple selected persons 244, each of which may be displayed on the display 210. One or more of the selected persons may be tagged, or not, depending on the technology used to track the persons, and the features desired with respect to communicating with the tracked persons. Thus, the system 250 may include one or more apparatus 100, machines 106, and tags 156 (see FIGS. 1A and 1B).

The image 240 may include, or be accompanied by other features as well. For example, the image 240 may include a time-stamp T associated with the time the predetermined location 248 is determined (e.g., fixing the location of the selected person 244 at the predetermined location 248 at a specific time). The predetermined location 248 may be displayed as part of the image 240 (or apart from the image 240) as well. In some embodiments, the display 210 may be used to display a map M of a route from the predetermined location 248 to one or more of the wagering game machines 202. The display 210 may also be used to publish winnings W associated with the selected person 244 for preselected events (e.g., the grand prize winner of a progressive series) and/or time periods (e.g., the highest cumulative winnings attributed to a single patron at a casino during the previous hour).

As noted previously, the display 210 of the image 240 may be activated in response to the occurrence of various events. For example, the display 210 may be activated responsive to the wagering game machine server 206 receiving information 236 from one of the wagering game machines 202. The display 210 of the image 240 may be activated in response to the predetermined location 248 coinciding with a selected rule RULES, such as the selected person 244 leaving a designated area, or entering a designated area.

A history HISTORY of the predetermined location 248 over time may be saved in a memory 230 of the wagering game machine server 206. The history HISTORY may be used in a number of ways. For example, the wagering game machine server 206 may use the history HISTORY to determine casino floor plan usage based on the predetermined location 248 as it changes over time, for one or more selected persons.

When the wagering game server 206 is includes as part of the system 250, several additional embodiments may be realized. For example, the wagering game machine server 206 may be used to push one or more selected games GAME to one or more selected wagering game machines 202 based on the predetermined location 248 of selected patrons, perhaps based on the record of the location, or its history HISTORY over time.

In some embodiments, the wagering game machine server 206 may be used to release physical objects (e.g., confetti, balloons, water, etc.) 274 proximate to the predetermined location 248, perhaps responsive to a preselected event associated with one or more of the wagering game machines 202. The system 250 may also include a plurality of lights 278 and audio tracks 282 coupled to the wagering game machine server 206, to be activated proximate to the predetermined location 248 responsive to a preselected event associated with one or more of the wagering game machines 202.

The wagering game machines 202 and wagering game server 206 can include hardware and machine-readable media, such as the memory 130 (FIG. 1A) and memory 230, having instructions stored thereon for performing the operations described herein.

The wagering game machines 202 described herein can take any suitable form, such as floor standing models, handheld mobile units, bar-top models, workstation-type console models, etc. Further, the wagering game machines 202 can be primarily dedicated for use in conducting wagering games, or can include non-dedicated devices, such as mobile phones, personal digital assistants, personal computers, etc. In one embodiment, the wagering game network 200 can include other network devices, such as accounting servers, wide area progressive servers, player tracking servers, and/or other devices suitable for use in connection with embodiments of the invention.

### Example Wireless Environment

In some embodiments, the wireless access point 204 and wagering game machines 202 can communicate orthogonal frequency division multiplexed (OFDM) communication signals over a multicarrier communication channel, perhaps comprising a plurality of orthogonal subcarriers. In some embodiments, the multicarrier signals can be defined by closely spaced OFDM subcarriers. Each subcarrier can have a null at substantially the center frequency of the other subcarriers and/or each subcarrier can have an integer number of cycles within a symbol period. In some embodiments, the wireless access point 204 and wagering game machines 202 can communicate in accordance with a broadband multiple access technique, such as orthogonal frequency division multiple access (OFDMA). In some embodiments, the wireless access point 204 and wagering game machines 202 can communicate using spread-spectrum signals.

In some embodiments, the wireless access point 204 can be part of a communication station, such as wireless local area network (WLAN) communication station including a Wireless Fidelity (WiFi) communication station, or a WLAN access point (AP). In these embodiments, the wagering game machines 202 can be part of a mobile station, such as WLAN mobile station or a WiFi mobile station.

In some embodiments, the wireless access point 204 can be part of a broadband wireless access (BWA) network communication station, such as a Worldwide Interoperability for Microwave Access (WiMax) communication station, as the wireless access point 204 can be part of almost any wireless communication device. In these embodiments, the wagering game machines 202 can be part of a BWA network communication station, such as a WiMax communication station.

In some embodiments, any of the wagering game machines 202 can part of a portable wireless communication device, such as a personal digital assistant (PDA), a laptop or portable computer with wireless communication capability, a web tablet, a wireless telephone, a wireless headset, a pager, an instant messaging device, a digital camera, a television, a medical device (e.g., a heart rate monitor, a blood pressure monitor, etc.), or other device that can receive and/or transmit information wirelessly.

In some embodiments, the wireless access point 204 and the wagering game machines 202 can communicate RF signals in accordance with specific communication standards, such as the Institute of Electrical and Electronics Engineers (IEEE) standards including IEEE 802.11(a), 802.11(b), 802.11(g), 802.11(h) and/or 802.11(n) standards and/or proposed specifications for wireless local area networks. In some BWA network embodiments, the wireless access point 204 and the wagering game machines 202 can communicate RF signals in accordance with the IEEE 802.16-2004 and the IEEE 802.16(e) standards for wireless metropolitan area networks (WMANs) including variations and evolutions thereof. However, it should be noted that the access points 204 and game machines 202 can also be suitable to transmit and/or receive communications in accordance with other techniques and standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and “Metropolitan Area Networks—Specific Requirements—Part 16: “Air Interface for Fixed Broadband Wireless Access Systems,” 2004 and related amendments/versions.

In some embodiments, the wireless access point 204 and the wagering game machines 202 can include one or more antennas (not shown). The tags 256 may also include such antennas. These antennas can comprise directional or omnidirectional antennas, including, for example, dipole antennas, monopole antennas, patch antennas, loop antennas, microstrip antennas or other types of antennas suitable for transmission of the RF signals. In some multiple-input, multiple-output (MIMO) embodiments, two or more antennas can be used. In some embodiments, instead of two or more antennas, a single antenna with multiple apertures can be used. In these multiple aperture embodiments, each aperture can be considered a separate antenna. In some multi-antenna embodiments, each antenna can be effectively separated to take advantage of spatial diversity and the different channel characteristics that can result between each of the antennas and another wireless communication device. In some multi-antenna embodiments, the antennas of a device can be separated by up to 1/10 of a wavelength or more.

In some embodiments, the wireless access point 204 and the wagering game machines 202 can communicate in accordance with standards such as the Pan-European mobile system standard referred to as the Global System for Mobile Communications (GSM). In some embodiments, the wireless access point 204 and the wagering game machines 202 can also communicate in accordance with packet radio services such as the General Packet Radio Service (GPRS) packet data communication service. In some embodiments, the wireless access point 204 and the wagering game machines 202 can communicate in accordance with the Universal Mobile Telephone System (UMTS) for the next generation of GSM, which can, for example, implement communication techniques in accordance with 2.5 G and third generation (3 G) wireless standards (See 3GPP Technical Specification, Version 3.2.0, March 2000). In some of these embodiments, the wireless access point 204 and the wagering game machines 202 can provide packet data services (PDS) utilizing packet data protocols (PDP). In other embodiments, the wireless access point 204 and the wagering game machines 202 can communicate in accordance with other standards or other air-interfaces including interfaces compatible with the enhanced data for GSM evolution (EDGE) standards (see 3GPP Technical Specification, Version 3.2.0, March 2000).

In other embodiments, the wireless access point 204 and the wagering game machines 202 can communicate in accordance with a short-range wireless standard, such as the Bluetooth™ short-range digital communication protocol. Bluetooth™ wireless technology is a de facto standard, as well as a specification for small-form factor, low-cost, short-range radio links between mobile PCs, mobile phones and other portable devices. (Bluetooth is a trademark owned by Bluetooth SIG, Inc.) In other embodiments, the wireless access point 204 and the wagering game machines 202 can communicate in accordance with an ultra-wideband (UWB) communication technique where a carrier frequency is not used. In other embodiments, the wireless access point 204 and the wagering game machines 202 can communicate in accordance with an analog communication technique. In other embodiments, the wireless access point 204 and the wagering game machines 202 can communicate in accordance with an optical communication technique, such as the Infrared Data Association (IrDA) standard. In some embodiments, the wireless access point 204 and the wagering game machines 202 can communicate in accordance with the Home-RF standard which can be in accordance with a Home-RF Working Group (HRFWG) standard.

Any of the components previously described can be implemented in a number of ways, including simulation via software. Thus, the wagering apparatus 100; wagering game machine 106; payout mechanism 108; primary display 110; secondary display 112; value input device 114; player input device 116; information reader 118; I/O bus 122; external system interface 124; CPU 126; memory 128; storage unit 130; wagering game presentation unit 132; alarms 134, 234; images 140, 240; persons 144, 244; predetermined locations 148, 248; LDUs 152, 252; tags 156, 256; transceiver 158; audio communication module 160; video communication module 162; vibratory element 164; processor 166; function indicator 170; wagering game network 200; wagering game machines 202; wireless access point 204; wagering game server 206; wired communication links 208; wireless communication links 210; casinos 212; communications network 214; local area network 216; system 250; physical objects 274; lights 278; audio tracks 282; history HISTORY; information INFO; map M; rule RULES; time-stamp T; and winnings W may all be characterized as “modules” herein.

These modules may include hardware circuitry, single or multi-processor circuits, memory circuits, software program modules and objects, firmware, and combinations thereof, as desired by the architect of the apparatus 100 and systems 250, and as appropriate for particular implementations of various embodiments. In some embodiments, the modules may be included in a system operation simulation package such as a software electrical signal simulation package, a power usage and distribution simulation package, a network security simulation package, a signal transmission-reception simulation package, or any combination of software and hardware used to simulate the operation of various potential embodiments. Such simulations may be used to characterize or test the embodiments, for example.

It should also be understood that the apparatus and systems of various embodiments can be used in applications other than wagering game machines. Thus, various embodiments of the invention are not to be so limited. The illustrations of apparatus 100 and systems 250 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, and application-specific modules, including multilayer, multi-chip modules. Such apparatus and systems may further be included as sub-components within a variety of electronic systems, such as data bridges, switches, and hubs; televisions and cellular telephones; personal digital assistants; personal computers and workstations; medical devices; radios and video players; and vehicles, among others. Thus, many additional embodiments may be realized.

### Example Operations

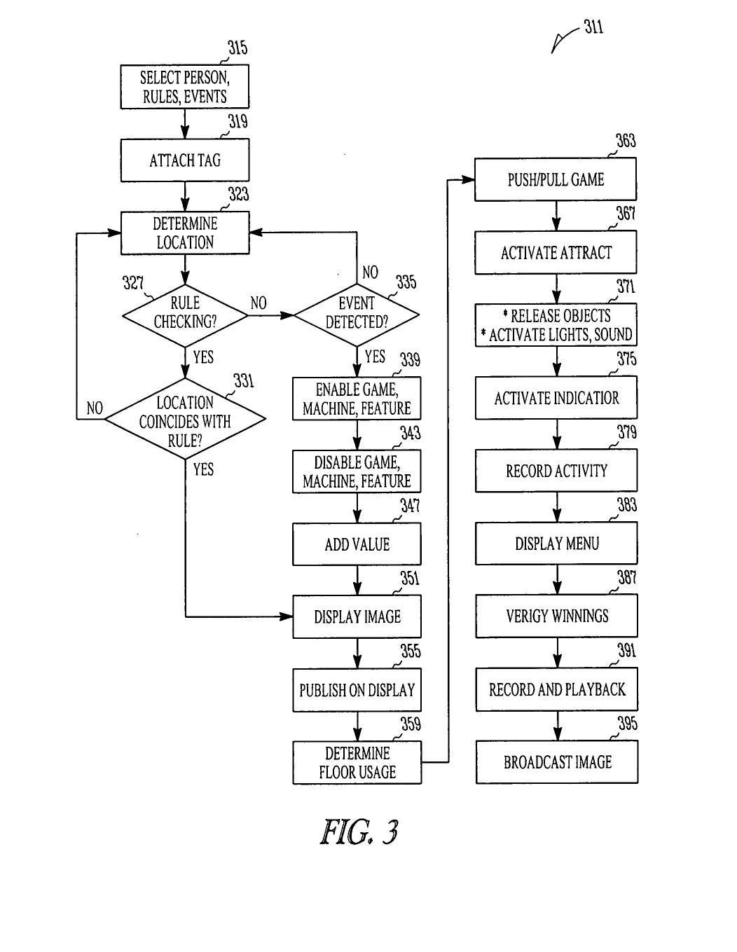

For example, FIG. 3 is a flowchart illustrating various methods 311 of linking locations to selected rules, events, and persons, according to example embodiments of the invention. A method 311 may begin with selecting one or more persons for tracking (resolving their predetermined location or locations over time) at block 315. Rules for generating, transmitting, broadcasting and displaying images, or events which trigger such activities may also be selected at this time. In some embodiments, the method 311 may include attaching a tag to one or more selected persons to assist in generating location information for those persons at block 319.

In many embodiments, the method 311 includes determining the location of one or more selected persons in a selected venue, such as a casino, at block 323. Determining the location may include determining the location of a tag attached to the selected person. However, some embodiments may dispense with attaching tags entirely, perhaps using biometric information (e.g., facial features), apparel features, audio information, or other video information to determine the location. In some embodiments, determining the location at block 323 may include determining that the location is within a selected distance of a wagering game machine to initiate a process of accessing a gaming machine control system included in the wagering game machine, responsive to the detecting (e.g., for convenient access by machine attendants).

If rule checking is not employed at block 327, then the method 311 may proceed to block 335. If rule checking is employed, then the method 311 may proceed to block 331 to evaluate whether the predetermined location coincides with a selected rule (e.g., the selected person has entered or left a designated area). If no such coincidence is determined at block 331, then the method may proceed to block 323.

At block 335, the method 311 may include detecting the occurrence of a preselected event associated with the selected person. If no such occurrence is detected, then the method 311 may proceed to block 323.

If the occurrence of a preselected event is detected at block 335, then the method 311 may proceed to block 339, enabling a number of activities. For example, the method 311 may include enabling one or more of a wagering game machine, a wagering game on a wagering game machine, or a game feature on a wagering game machine based on the location (and/or the detecting). Similarly, the method 311 may include disabling one or more of a wagering game machine, a wagering game on a wagering game machine, or a game feature on a wagering game machine responsive to the detecting (and/or the location) at block 343. The method 311 may also include adding value to an account associated with the selected person responsive to the detecting at block 347.

At block 351, the method 311 may include displaying a video image of the selected person on a display responsive to the detecting. For example, the event detected may simply be the receipt of a wager at a particular wagering game machine. Initial and/or continued display of the image may be conditioned on receiving a particular number or cumulative amount of wagers over a selected period of time.

Once the image is displayed, additional elements may be added to the display, and other activities initiated. For example, the method 311 may include publishing, on the display and responsive to the detecting, winnings associated with the selected person in conjunction with a preselected event and/or a selected time period at block 355.

As mentioned previously, some embodiments of the method 311 may include, at block 359, determining casino floor plan usage based on the location. Further included at block 363 may be pushing one or more selected games to a plurality of wagering game machines and/or removing one or more selected games from a selected wagering game machine.

In some embodiments, the method 311 may include activating an attract package responsive to the detecting at block 367. The method 311 may also include releasing physical objects into the casino, proximate to the location, responsive to the detecting, at block 371. Variants may include activating one or more lights and audio tracks, proximate to the location, responsive to the detecting. The method 311 may include activating a function indicator on a tag attached to the selected person to communicate information to the selected person at block 375.

In some embodiments, wagering game machine attendant activity may be monitored. For example, the method 311 may include recording wagering game machine attendant activity associated with the selected person, or with a selected wagering game machine responsive to the detecting at block 379. The method 311 may also include displaying a menu on a selected wagering game machine responsive to the detecting at block 383.

In some embodiments, the method 311 may include verifying winnings associated with a selected wagering game machine responsive to the detecting at block 387. Significant events may also be recorded, such that the method 311 includes recording the video image and playing the video image back to be viewed by casino security personnel or a plurality of casino patrons at block 391. Recording the video image over a selected time period may also be included at block 391. In some embodiments, the method 311 may include recording the video image as one of a series of video images obtained from one or more sources, and playing the series of video images back as a movie.

The video image may be broadcast to one or more of selected wagering game machines, a global computer network, a bar-top monitor, a casino maintenance monitor, a security monitor, and/or a casino hotel television system, at block 395. It should be noted that in any of the embodiments of the apparatus, systems, and methods disclosed herein, the person(s) selected for tracking may also be wagering game machine player(s).

The methods described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

One of ordinary skill in the art will understand the manner in which a software program can be launched from a computer-readable medium in a computer-based system to execute the functions defined in the software program. Various programming languages may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment.

Thus, other embodiments may be realized, including a machine-readable medium encoded with instructions for directing a machine to perform operations comprising any of the methods described herein. For example, some embodiments may include a machine-readable medium encoded with instructions for directing a wagering game machine operable to receive a wager to perform a variety of operations. Such operations may include determining the location of a selected person in a casino, detecting the occurrence of a preselected event associated with the selected person, and displaying a video image of the selected person on a display responsive to the detecting. Other operations may include any of the activities presented in conjunction with the methods 311 described above.

### Example Wagering Game Machines

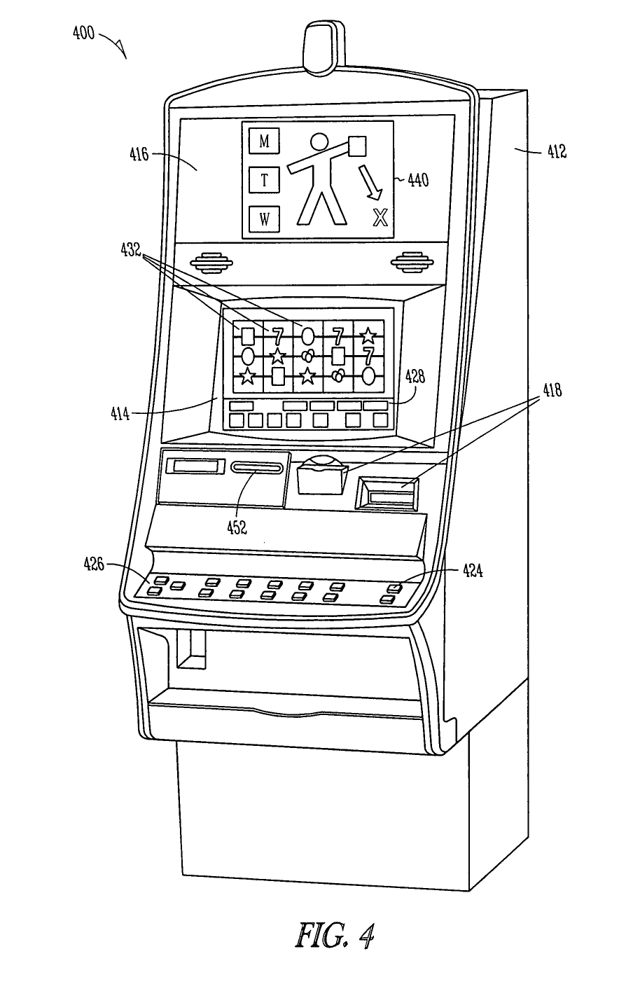

FIG. 4 is a perspective view of a free standing wagering game machine 400 according to example embodiments of the invention. The wagering game machine 400 is used in gaming establishments, such as casinos. According to embodiments, the wagering game machine 400 can be any type of wagering game machine and can have varying structures and methods of operation. For example, the wagering game machine 400 can be an electromechanical wagering game machine configured to play mechanical slots, or it can be an electronic wagering game machine configured to play video casino games, such as blackjack, slots, keno, poker, blackjack, roulette, etc.

The wagering game machine 400 comprises a housing 412 and includes input devices, including value input devices 418 and a player input device 424. For output, the wagering game machine 400 includes a primary display 414 for displaying information about a basic wagering game. The primary display 414 can also display information about a bonus wagering game and a progressive wagering game. The wagering game machine 400 also includes a secondary display 416 for displaying wagering game events, wagering game outcomes, and/or signage information. While some components of the wagering game machine 400 are described herein, numerous other elements can exist and can be used in any number or combination to create varying forms of the wagering game machine 400. For example, either one or both of the wagering game machine displays 414, 416 may be used to display an image 440 of a selected person at a predetermined location, including any or all of the variants described above with respect to FIGS. 1A, 2, and 3. As shown in FIG. 4, the image 440 is displayed in a picture-in-picture format.

The value input devices 418 can take any suitable form and can be located on the front of the housing 412. The value input devices 418 can receive currency and/or credits inserted by a player. The value input devices 418 can include coin acceptors for receiving coin currency and bill acceptors for receiving paper currency. Furthermore, the value input devices 418 can include ticket readers or bar code scanners for reading information stored on vouchers, cards, or other tangible portable storage devices. The vouchers or cards can authorize access to central accounts, which can transfer money to the wagering game machine 400.

The player input device 424 may comprise a plurality of push buttons on a button panel 426 for operating the wagering game machine 400. In addition, or alternatively, the player input device 424 can comprise a touch screen 428 mounted over the primary display 414 and/or secondary display 416.

The various components of the wagering game machine 400 can be connected directly to, or contained within, the housing 412. Alternatively, some of the wagering game machine's components can be located outside of the housing 412, while being communicatively and remotely coupled with the wagering game machine 400 using any suitable wired or wireless communication technology.

The operation of the basic wagering game can be displayed to the player on the primary display 414. The primary display 414 can also display a bonus game associated with the basic wagering game. The primary display 414 can include a cathode ray tube (CRT), a high resolution liquid crystal display (LCD), a plasma display, light emitting diodes (LEDs), or any other type of display suitable for use in the wagering game machine 400. Alternatively, the primary display 414 can include a number of mechanical reels to display the outcome. In FIG. 4, the wagering game machine 400 is an “upright” version in which the primary display 414 is oriented vertically relative to the player. Alternatively, the wagering game machine can be a “slant-top” version in which the primary display 414 is slanted at about a thirty-degree angle toward the player of the wagering game machine 400. In yet another embodiment, the wagering game machine 400 can exhibit any suitable form factor, such as a free standing model, bar-top model, mobile handheld model, or workstation console model.

A player begins playing a basic wagering game by making a wager via the value input device 418. The player can initiate play by using the player input device's buttons or touch screen 428. The basic game can include arranging a plurality of symbols along a payline 432, which indicates one or more outcomes of the basic game. Such outcomes can be randomly selected in response to player input. At least one of the outcomes, which can include any variation or combination of symbols, can trigger a bonus game.

In some embodiments, the wagering game machine 400 can also include an information reader 452, which can include a card reader, ticket reader, bar code scanner, RFID transceiver, or computer readable storage medium interface. In some embodiments, the information reader 452 can be used to award complimentary services, restore game assets, track player habits, etc.

### Example Wagering Game Machine

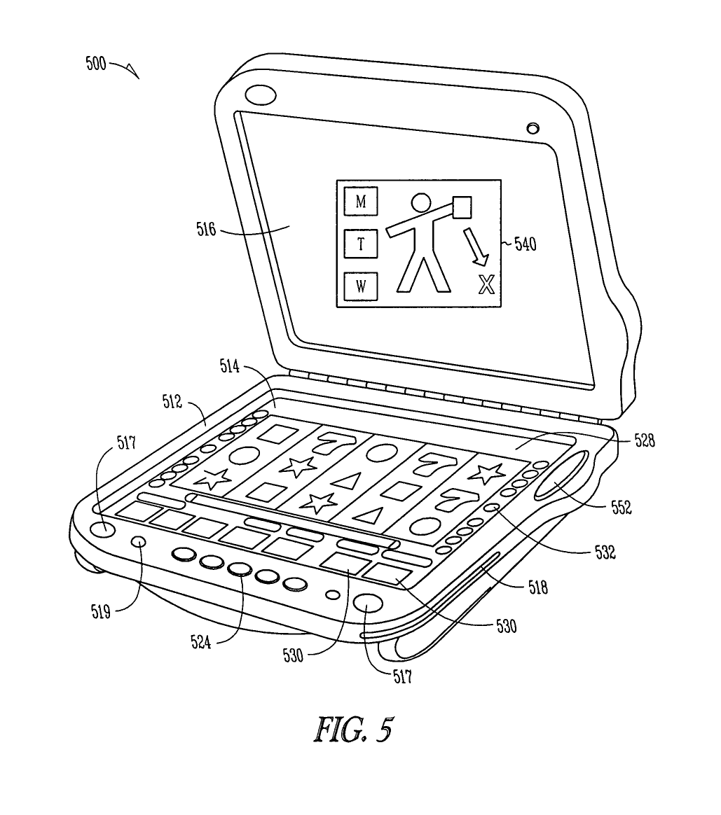

FIG. 5 is a perspective view of a mobile wagering game machine 500 according to example embodiments of the invention. Like free standing wagering game machines (e.g., see FIG. 4), in a handheld or mobile form, the wagering game machine 410 can include any suitable electronic device configured to play a video casino games such as blackjack, slots, keno, poker, blackjack, and roulette. The wagering game machine 500 comprises a housing 512 and includes input devices, including a value input device 518 and a player input device 524. For output, the wagering game machine 500 includes a primary display 514, a secondary display 516, one or more speakers 517, one or more player-accessible ports 519 (e.g., an audio output jack for headphones, a video headset jack, etc.), and other conventional I/O devices and ports, which may or may not be player-accessible. In the embodiment depicted in FIG. 5, the wagering game machine 500 comprises a secondary display 516 that is rotatable relative to the primary display 514. The optional secondary display 516 can be fixed, movable, and/or detachable/attachable relative to the primary display 514. Either the primary display 514 and/or secondary display 516 can be configured to display any aspect of a non-wagering game, wagering game, secondary game, bonus game, progressive wagering game, group game, shared-experience game or event, game event, game outcome, scrolling information, text messaging, emails, alerts or announcements, broadcast information, subscription information, and wagering game machine status. For example, either one or both of the wagering game machine displays 514, 516 may be used to display an image 540 of a selected person at a predetermined location, including any or all of the variants described above with respect to FIGS. 1A, 2, 3, and 4. As shown in FIG. 5, the image 540 is displayed in a picture-in-picture format.

The player-accessible value input device 518 can comprise, for example, a slot located on the front, side, or top of the casing 512 configured to receive credit from a stored-value card (e.g., casino card, smart card, debit card, credit card, etc.) inserted by a player. The player-accessible value input device 518 can also comprise a sensor (e.g., an RF sensor) configured to sense a signal (e.g., an RF signal) output by a transmitter (e.g., an RF transmitter) carried by a player. The player-accessible value input device 518 can also or alternatively include a ticket reader, or bar code scanner, for reading information stored on a credit ticket, a card, or other tangible portable credit or funds storage device. The credit ticket or card can also authorize access to a central account, which can transfer money to the wagering game machine 500.

Still other player-accessible value input devices 518 can require the use of touch keys 530 on the touch-screen display (e.g., primary display 514 and/or secondary display 516) or player input devices 524. Upon entry of player identification information and, preferably, secondary authorization information (e.g., a password, PIN number, stored value card number, predefined key sequences, etc.), the player can be permitted to access a player's account. As one potential optional security feature, the wagering game machine 500 can be configured to permit a player to only access an account the player has specifically set up for the wagering game machine 500. Other conventional security features can also be utilized to, for example, prevent unauthorized access to a player's account, to minimize an impact of any unauthorized access to a player's account, or to prevent unauthorized access to any personal information or funds temporarily stored on the wagering game machine 500.

The player-accessible value input device 518 can itself comprise or utilize a biometric player information reader which permits the player to access available funds on a player's account, either alone or in combination with another of the aforementioned player-accessible value input devices 518. In an embodiment wherein the player-accessible value input device 518 comprises a biometric player information reader, transactions such as an input of value to the wagering game machine 500, a transfer of value from one player account or source to an account associated with the wagering game machine 500, or the execution of another transaction, for example, could all be authorized by a biometric reading, which could comprise a plurality of biometric readings, from the biometric device.

Alternatively, to enhance security, a transaction can be optionally enabled only by a two-step process in which a secondary source confirms the identity indicated by a primary source. For example, a player-accessible value input device 518 comprising a biometric player information reader can require a confirmatory entry from another biometric player information reader 552, or from another source, such as a credit card, debit card, player ID card, fob key, PIN number, password, hotel room key, etc. Thus, a transaction can be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 518 can be provided remotely from the wagering game machine 500.

The player input device 524 comprises a plurality of push buttons on a button panel for operating the wagering game machine 500. In addition, or alternatively, the player input device 524 can comprise a touch screen mounted to a primary display 514 and/or secondary display 516. In one aspect, the touch screen is matched to a display screen having one or more selectable touch keys 530 selectable by a user's touching of the associated area of the screen using a finger or a tool, such as a stylus pointer. A player enables a desired function either by touching the touch screen at an appropriate touch key 530 or by pressing an appropriate push button on the button panel. The touch keys 530 can be used to implement the same functions as push buttons. Alternatively, the push buttons 526 can provide inputs for one aspect of the operating the game, while the touch keys 530 can allow for input needed for another aspect of the game. The various components of the wagering game machine 500 can be connected directly to, or contained within, the casing 512, as seen in FIG. 5, or can be located outside the casing 512 and connected to the casing 512 via a variety of wired (tethered) or wireless connection methods. Thus, the wagering game machine 500 can comprise a single unit or a plurality of interconnected (e.g., wireless connections) parts which can be arranged to suit a player's preferences.

The operation of the basic wagering game on the wagering game machine 500 is displayed to the player on the primary display 514. The primary display 514 can also display the bonus game associated with the basic wagering game. The primary display 514 preferably takes the form of a high resolution LCD, a plasma display, an LED, or any other type of display suitable for use in the wagering game machine 500. The size of the primary display 514 can vary from, for example, about a 2-3″ display to a 15″ or 17″ display. In at least some embodiments, the primary display 514 is a 7″-10″ display. In one embodiment, the size of the primary display can be increased. Optionally, coatings or removable films or sheets can be applied to the display to provide desired characteristics (e.g., anti-scratch, anti-glare, bacterially-resistant and anti-microbial films, etc.). In at least some embodiments, the primary display 514 and/or secondary display 516 can have a 16:9 aspect ratio or other aspect ratio (e.g., 4:3). The primary display 514 and/or secondary display 516 can also each have different resolutions, different color schemes, and different aspect ratios.

As with the free standing embodiments a wagering gaming machine, a player begins play of the basic wagering game on the wagering game machine 500 by making a wager (e.g., via the value input device 518 or an assignment of credits stored on the handheld gaming machine via the touch screen keys 530, player input device 524, or buttons 526) on the wagering game machine 500. In some embodiments, the basic game can comprise a plurality of symbols arranged in an array, and includes at least one payline 532 that indicates one or more outcomes of the basic game. Such outcomes can be randomly selected in response to the wagering input by the player. At least one of the plurality of randomly selected outcomes can be a start-bonus outcome, which can include any variations of symbols or symbol combinations triggering a bonus game.

In some embodiments, the player-accessible value input device 518 of the wagering game machine 500 can double as a player information reader 552 that allows for identification of a player by reading a card with information indicating the player's identity (e.g., reading a player's credit card, player ID card, smart card, etc.). The player information reader 552 can alternatively or also comprise a bar code scanner, RFID transceiver or computer readable storage medium interface. In one embodiment, the player information reader 552 comprises a biometric sensing device.

Implementing the apparatus, systems, and methods described herein may impart a new flexibility to managing casinos and other wagering game machine entertainment venues. Numerous variations on the themes described herein are possible. These include, for example, monitoring a variety of persons (children, patrons, employees) upon entry or leaving a designated area to improve personal safety, as a matter of convenience, or to detect fraud. Also included may be monitoring group behavior (employees, patrons, and selected combinations thereof) to improve facility use (find popular areas, high-traffic areas, or poorly used areas), and to detect fraud. Monitoring game results and location to promote/advertise wins or special events, or playback big wins, may also be included.

Further elements include tracking personnel location over time to provide a history of location and activity, to detect fraud, to prove the identity of winners, to enforce voluntary bans on gaming activity, to monitor attendant service activity, to monitor cleaning activity, to provide food/drink service (e.g., after a patron has left the ordering location), or to provide maps to other locations (e.g., a selected new location, diversion for advertising, or returning to a casino entry point).

Picture-in-picture monitoring at a wagering game machine, using a hand-held device, or the Internet may also be implemented. Rule-based tracking (e.g., based on selected number of wins, entry into a prohibited area, using a player-determined selection or buddy list) can also be used. Finally, any number of monitored events may be used to activate image displays, or to put into action subsequent events in conjunction with image displays, including tracking personnel that wear cameras, and using events to trigger selected actions, such as entertainment events (e.g., lights, sounds, tactile objects (water, confetti), fog, scents, special offers to patrons), dispatching personnel with a prize or food/drink to the current location of selected persons, zoomed-video monitoring, and tracking to re-arrange game distribution by wagering game machine servers.

### General

In the preceding detailed description, reference is made to specific examples by way of drawings and illustrations. These examples are described in sufficient detail to enable those skilled in the art to practice the inventive subject matter, and serve to illustrate how the inventive subject matter may be applied to various purposes or embodiments. Other embodiments are included within the inventive subject matter, as logical, mechanical, electrical, and other changes may be made to the example embodiments described herein. Features or limitations of various embodiments described herein, however essential to the example embodiments in which they are incorporated, do not limit the inventive subject matter as a whole, and any reference to the invention, its elements, operation, and application are not limiting as a whole, but serve only to define these example embodiments.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus comprising:
a wagering game machine having a wagering game presentation unit operable to receive a wager from a player in association with a wagering game; and
a display to present an image of a person at a predetermined location, wherein the person is selected by the player.

2. The apparatus of claim 1, wherein the predetermined location is determined using location information derived from at least one of time-of-arrival, angle-of-arrival, time-difference of arrival, phase-difference of arrival, and global positioning system information.

3. The apparatus of claim 1, wherein the image includes a time-stamp associated with a time of determining the predetermined location.

4. The apparatus of claim 1, including:
a location determination unit to determine the predetermined location.

5. The apparatus of claim 1, including:
a tag to attach to the person and to provide data to determine the predetermined location.

6. The apparatus of claim 5, wherein the tag further includes:
a communication receiver to receive audio information directed to the person.

7. The apparatus of claim 5, wherein the tag further includes:
a vibratory element to convey vibration information to the person.

8. The apparatus of claim 1, wherein the display is included in the wagering game machine.

9. The apparatus of claim 1, wherein the display is included as a part of a picture-in-picture display of the wagering game machine.

10. The apparatus of claim 1, wherein the image comprises a composite scene including the person.

11. The apparatus of claim 1, wherein the display is included in a bar-top display to be viewed by casino personnel.

12. The apparatus of claim 1, wherein the display is included in a security video display to be viewed by casino personnel.

13. The apparatus of claim 1, wherein the display is activated in response to the predetermined location coinciding with a selected rule.

14. The apparatus of claim 13, wherein the selected rule includes activating the display responsive to the person leaving a designated area.

15. The apparatus of claim 13, wherein the selected rule includes activating the display responsive to the person entering a designated area.

16. The apparatus of claim 1, wherein a history of the predetermined location over time is saved in a memory of the wagering game machine.

17. The apparatus of claim 1, wherein the display is to display a map of a route from the predetermined location to the wagering game machine.

18. The apparatus of claim 1, wherein an alarm is activated in response to the predetermined location coinciding with a selected rule.

19. The apparatus of claim 1, wherein the location is correlated with winnings associated with the wagering game machine to detect fraud.

20. The apparatus of claim 1, wherein the wagering game machine includes an audio communication module to communicate with the person.

21. The apparatus of claim 1, wherein the image is communicated to a global communications network.

22. The apparatus of claim 1, wherein the image is blurred around the person.

23. The apparatus of claim 1, wherein the image is limited to a fixed amount of physical space surrounding the person.

24. A system, including:
a wagering game machine server coupled to at least one wagering game machine operable to receive a wager in association with a wagering game; and
a display in communication with the wagering game machine server, the display to present an image of a selected person at a predetermined location.

25. The system of claim 24, wherein the wagering game machine server is to determine the predetermined location.

26. The system of claim 24, wherein the at least one wagering game machine is to determine the predetermined location.

27. The system of claim 24, wherein the display is to display locations of a plurality of tagged persons, including the predetermined location.

28. The system of claim 24, wherein the display is included in an audio-visual unit disposed apart from the server and to be viewed by a plurality of casino patrons.

29. The system of claim 24, wherein the display is activated responsive to the wagering game machine server receiving information from the at least one wagering game machine.

30. The system of claim 24, wherein the display is included in the at least one wagering game machine.

31. The system of claim 24, wherein the image includes a time-stamp associated with a time of determining the predetermined location.

32. The system of claim 24, including:
a tag to attach to the selected person and to provide data to determine the predetermined location.

33. The system of claim 32, wherein the tag comprises one of a radio-frequency identification device, a bracelet, a hotel room card, and a credit card.

34. The system of claim 32, wherein the tag further includes:
a communication receiver to receive audio information directed to the selected person.

35. The system of claim 32, wherein the tag further includes:
a vibratory element to convey vibration information to the selected person.

36. The system of claim 32, wherein the tag further includes:
a communication receiver to receive video information directed to the selected person.

37. The system of claim 24, wherein the display is included in a bar-top display to be viewed by casino personnel.

38. The system of claim 24, wherein the display is included in a security video display to be viewed by casino personnel.

39. The system of claim 24 wherein the display is activated in response to the predetermined location coinciding with a selected rule.

40. The system of claim 39, wherein the selected rule includes activating the display responsive to the selected person leaving a designated area.

41. The system of claim 39, wherein the selected rule includes activating the display responsive to the selected person entering a designated area.

42. The system of claim 24, wherein a history of the predetermined location over time is saved in a memory of the wagering game machine server.

43. The system of claim 24, wherein the display is to display a map of a route from the predetermined location to the at least one wagering game machine.

44. The system of claim 24, wherein an alarm is activated in response to the predetermined location coinciding with a selected rule.

45. The system of claim 24, wherein the predetermined location is correlated with winnings associated with the at least one wagering game machine to detect fraud.

46. The system of claim 24, wherein the display is to publish winnings associated with the selected person for one of a preselected event and a selected time period.

47. The system of claim 24, wherein the wagering game machine server is to determine casino floor plan usage based on the predetermined location.

48. The system of claim 24, wherein the wagering game machine server is to push at least one selected game to the at least one wagering game machine based on the predetermined location.

49. The system of claim 24, wherein the wagering game machine server is to release physical objects proximate to the predetermined location, responsive to a preselected event associated with the at least one wagering game machine.

50. The system of claim 24, including:
a plurality of lights and audio tracks coupled to the wagering game machine server, to be activated proximate to the predetermined location, responsive to a preselected event associated with the at least one wagering game machine.

51. A method comprising:
determining a location of a selected person in a casino;
detecting an occurrence of a preselected event associated with the selected person; and
displaying a video image of the selected person on a display responsive to the detecting.

52. The method of claim 51, wherein the display is coupled to a wagering game machine server.

53. The method of claim 51, including:
disabling one of a wagering game machine, a wagering game on a wagering game machine, and a game feature on a wagering game machine responsive to the detecting.

54. The method of claim 51, including:
enabling one of a wagering game machine, a wagering game on a wagering game machine, and a game feature on a wagering game machine based on the location.

55. The method of claim 51, including:
adding value to an account associated with the selected person responsive to the detecting.

56. The method of claim 51, including:
publishing, on the display and responsive to the detecting, winnings associated with the selected person in conjunction with one of the preselected event and a selected time period.

57. The method of claim 51, including:
determining casino floor plan usage based on the location.

58. The method of claim 57, wherein the determining includes:
pushing at least one selected game to a plurality of wagering game machines responsive to the video image.

59. The method of claim 57, wherein the determining includes:
removing at least one selected game from a selected wagering game machine responsive to the video image.

60. The method of claim 51, including:
activating an attract package responsive to the detecting.

61. The method of claim 51, including:
releasing physical objects into the casino, proximate to the location, responsive to the detecting.

62. The method of claim 51, including:
activating at least one of a plurality of lights and audio tracks, proximate to the location, responsive to the detecting.

63. The method of claim 51, wherein the determining includes determining the location of a tag attached to the selected person.

64. The method of claim 51, including:
activating a function indicator on a tag attached to the selected person to communicate information to the selected person.

65. The method of claim 51, including:
determining the location is within a selected distance of a wagering game machine to initiate a process of accessing a gaming machine control system included in the wagering game machine, responsive to the detecting.

66. The method of claim 51, including:
recording wagering game machine attendant activity associated with the selected person.

67. The method of claim 51, including:
recording wagering game machine attendant activity associated with a selected wagering game machine responsive to the detecting.

68. The method of claim 51, including:
displaying a menu on a selected wagering game machine responsive to the detecting.

69. The method of claim 51, including:
verifying winnings associated with a selected wagering game machine responsive to the detecting.

70. The method of claim 51, wherein the preselected event includes the selected person entering a designated area.

71. The method of claim 51, wherein the preselected event includes the selected person leaving a designated area.

72. The method of claim 51, including:
recording the video image; and
playing the video image back to be viewed by a plurality of casino patrons.

73. The method of claim 51, including:
recording the video image over a selected time period.

74. The method of claim 51, wherein the selected person is a player of a wagering game machine.

75. The method of claim 51, including:
broadcasting the video image to one of a wagering game machine, a global computer network, and a hotel television system.

76. The method of claim 51, including:
recording the video image as one of a series of video images obtained from at least two sources; and
playing the series of video images back as a movie.
